(19) United States
(12) Patent Application Publication
(10) Pub. No.: US 2024/0314842 A1
(43) Pub. Date: Sep. 19, 2024

(54) METHOD, DEVICE AND COMPUTER READABLE MEDIUM FOR COMMUNICATIONS

(71) Applicant: NEC CORPORATION, Tokyo (JP)

(72) Inventors: Gang WANG, Beijing (CN); Lin LIANG, Beijing (CN); Zhaobang MIAO, Beijing (CN)

(73) Assignee: NEC CORPORATION, Tokyo (JP)

(21) Appl. No.: 18/579,553

(22) PCT Filed: Aug. 16, 2021
(86) PCT No.: PCT/CN2021/112702

§ 371 Date: Jan. 16, 2024

(51) Int. Cl. H04W 74/0816; H04L 1/1829; H04W 92/18

(52) U.S. Cl. CPC H04W 74/0816; H04L 1/1854; H04W 92/18

(57) ABSTRACT

Embodiments of the present disclosure relate to methods, devices and computer readable media for communications. A method comprises determining, at a first terminal device, a value of a contention window based on at least one factor related to sidelink. The method also comprises performing, based on the value of the contention window, a channel access procedure for sidelink transmission.

### TECHNICAL FIELD

Embodiments of the present disclosure generally relate to the field of telecommunication, and in particular, to methods, devices and computer readable media for sidelink communication.

### BACKGROUND

Sidelink in unlicensed spectrum or band (SL-U) is a key topic in Release 18 of the 3rd Generation Partnership Project (3GPP).

For a sidelink terminal device working in unlicensed band, a channel access procedure should be used to access the channel. Before the sidelink terminal device performs the channel access procedure, a contention window (CW) should be determined.

For New Radio (NR) in unlicensed band (NR-U), the CW is mainly determined and adjusted based on Hybrid Automatic Repeat Request (HARQ) feedback. While the HARQ feedback is optional for sidelink communication. In other words, there may be no HARQ feedback available for CW determining. Therefore, the scheme for determining the CW in NR-U cannot work in SL-U.

### SUMMARY

In general, example embodiments of the present disclosure provide methods, devices and computer readable media for communications.

In a first aspect, there is provided a method for communications. The method comprises determining, at a first terminal device, a value of a contention window based on at least one factor related to sidelink. The method also comprises performing, based on the value of the contention window, a channel access procedure for sidelink transmission.

In a second aspect, there is provided a terminal device. The terminal device comprises a processor and a memory storing instructions. The memory and the instructions are configured, with the processor, to cause the terminal device to perform the method according to the first aspect.

In a third aspect, there is provided a computer readable medium having instructions stored thereon. The instructions, when executed on at least one processor of a device, cause the device to perform the method according to the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates a flowchart of an example method for determining CW in accordance with some embodiments of the present disclosure;

FIG. 3 illustrates a flowchart of an example method for determining CW in accordance with some other embodiments of the present disclosure;

FIG. 4 illustrates a flowchart of an example method for determining CW in accordance with still other embodiments of the present disclosure;

FIGS. 5A, 5B and 5C illustrate an example of sidelink HARQ feedbacks in accordance with some embodiments of the present disclosure, respectively;

FIG. 5D illustrates a flowchart of an example method for determining CW in accordance with still other embodiments of the present disclosure;

FIGS. 6A and 6B illustrate an example of determining CW based on reserved resources in accordance with some embodiments of the present disclosure, respectively;

FIG. 7A illustrates an example of determining CW based on sidelink CBR in accordance with some embodiments of the present disclosure;

FIG. 7B illustrates an example of determining CW based on sidelink CR in accordance with some embodiments of the present disclosure;

FIG. 7C illustrates a flowchart of an example method of determining CW based on SL CBR and SL CR in accordance with some embodiments of the present disclosure;

FIG. 8A illustrates a flowchart of an example method for determining CW based on a HARQ feedback and SL CBR in accordance with some embodiments of the present disclosure;

FIG. 8B illustrates a flowchart of an example method for determining CW based on a HARQ feedback and SCI in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, for NR-U, the CW is mainly determined and adjusted based on HARQ feedback. While the HARQ feedback is optional for sidelink communication. In other words, there may be no HARQ feedback available for CW determining. Therefore, the scheme for determining the CW in NR-U may not work in SL-U.

Embodiments of the present disclosure provide a solution for sidelink transmission so as to solve the above problems and one or more of other potential problems. According to the solution, a first terminal device determines a value of a CW based on at least one factor related to sidelink. In turn, the first terminal device performs, based on the value of the contention window, a channel access procedure for sidelink transmission. This solution may enable a channel access procedure for sidelink transmission in unlicensed band.

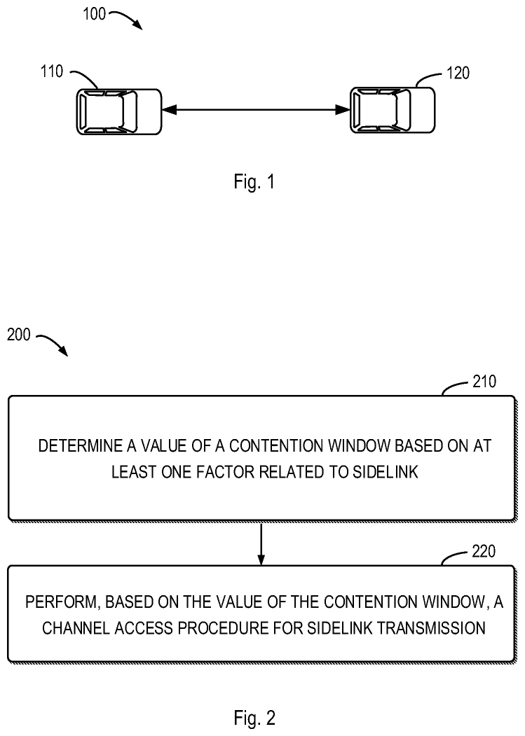

FIG. 1 illustrates a schematic diagram of an example communication network 100 in which embodiments of the present disclosure can be implemented. As shown in FIG. 1, the communication network 100 may include a first terminal device 110 and a second terminal device 120. It should be understood that the communication network 100 may further include a network device (not shown). The network device may communicate with the first terminal device 110 and the second terminal device 120 via respective wireless communication channels. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices. In this type of communication, two or more terminal devices that are geographically proximate to each other can directly communicate without going through a network device (e.g., an eNB in LTE system or a gNB in NR), or a core network. Data transmission in sidelink communication is thus different from typical cellular network communications, in which a terminal device transmits data to an eNB or a gNB (i.e., uplink transmissions) or receives data from an eNB or a gNB (i.e., downlink transmissions). In sidelink communication, data is transmitted directly from a source terminal device to a target terminal device through the Unified Air Interface, e.g., PC5 interface.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

In FIG. 1, the first terminal device 110 and the second terminal device 120 are shown as vehicles which enable V2X communication. It is to be understood that embodiments of the present disclosure are also applicable to other terminal devices than vehicles, such as mobile phones, sensors and so on.

The first terminal device 110 determines a value of a CW based on at least one factor related to sidelink. In turn, the first terminal device 110 performs, based on the value of the contention window, a channel access procedure for sidelink transmission.

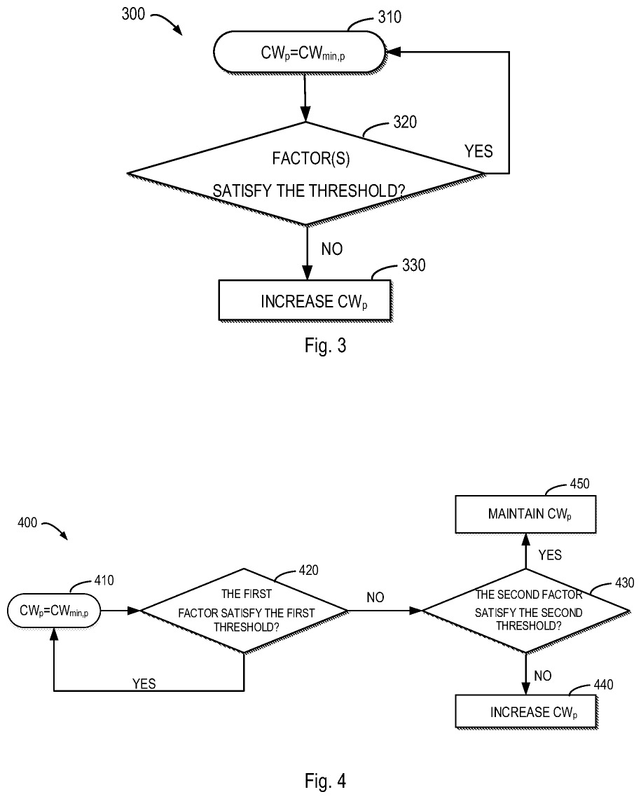

FIG. 2 illustrates a flowchart of an example method 200 in accordance with some embodiments of the present disclosure. In some embodiments, the method 200 can be implemented at a terminal device, such as the first terminal device 110 or the second terminal device 120 as shown in FIG. 1. For the purpose of discussion, the method 200 will be described with reference to FIG. 1 as performed by the first terminal device 110 without loss of generality.

At block 210, the first terminal device 110 determines a value of a CW based on at least one factor related to sidelink.

At block 220, the first terminal device 110 performs, based on the value of the CW, a channel access procedure for sidelink transmission.

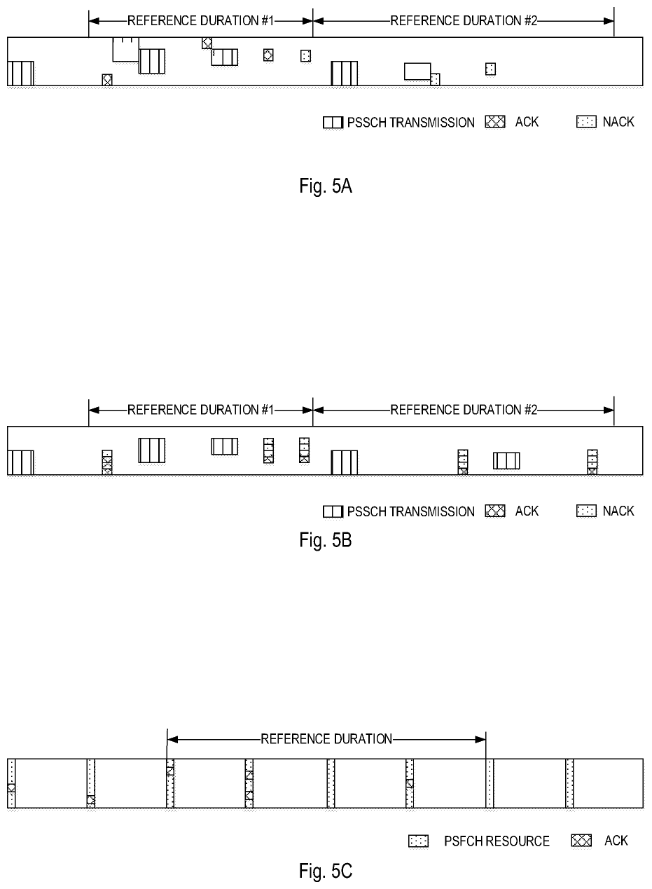

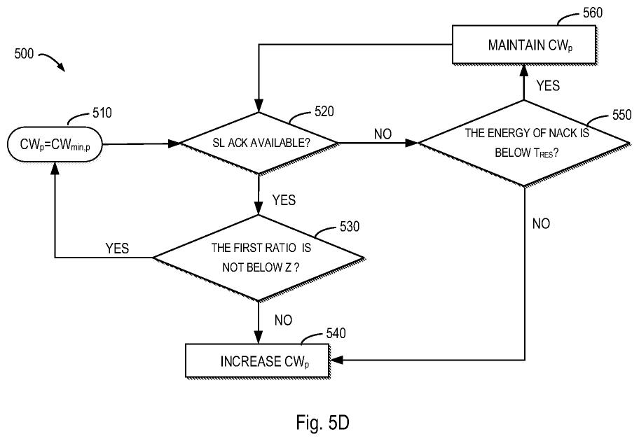

Hereinafter, general procedures of determining CW for SL-U will be described with reference to FIGS. 3 and 4.

FIG. 3 illustrates a flowchart of an example method 300 for determining a CW in accordance with some other embodiments of the present disclosure. In some embodiments, the method 300 can be implemented at a terminal device, such as the first terminal device 110 or the second terminal device 120 as shown in FIG. 1. For the purpose of discussion, the method 300 will be described with reference to FIG. 1 as performed by the first terminal device 110 without loss of generality.

In the example method 300, a value of a CW is determined based on one factor related to sidelink. As shown in FIG. 3, at block 310, the first terminal device 110 sets CWₚ to be CW_{min,p}, i.e., CWₚ=CW_{min,p}, where CWₚ represents a value of a CW for priority p, CW_{min,p} represents a minimum value of CWₚ for priority p.

At block 320, according to the determining rule of CWₚ, the first terminal device 110 determines whether the factor satisfies a threshold. The threshold may be configured or pre-configured. If the factor satisfies the threshold, the method 300 goes to block 310. Otherwise, the method 300 goes to block 330.

At block 330, the first terminal device 110 increases CWₚ. For example, the first terminal device 110 may increase CWₚ to the next higher allowed value for priority p.

In some embodiments, the allowed values of CWₚ for sidelink terminal devices may reuse the same sets of allowed values of CWₚ for terminal devices worked in NR-U.

Table 1 shows an example of sets of allowed values of CWₚ for terminal devices worked in NR-U.

| Channel Access | | | |
|---|---|---|---|
| Priority Class (p) | CW_{min, p} | CW_{max, p} | allowed values of CWₚ |
| 1 | 3 | 7 | {3, 7} |
| 2 | 7 | 15 | {7, 15} |
| 3 | 15 | 63 | {15, 31, 63} |
| 4 | 15 | 1023 | {15, 31, 63, 127, 255, 511, |
| | | | 1023} |

In Table 1, CW_{min,p} represents a minimum value of CWₚ for priority p, CW_{max,p} represents a maximum value of CWₚ for priority p, T_{mcot,p} represents a maximum channel occupancy time for priority p.

For example, as shown in Table 1, for priority of 1, the allowed values of CWₚ comprises 3 and 7. CW_{min,p} is 3 and the next higher allowed value is 7. At block 310, the first terminal device 110 may set CWₚ=3. If the first terminal device 110 determines that the factor does not satisfy a threshold, the first terminal device 110 may increase CWₚ to 7.

For another example, as shown in Table 1, for priority of 3, the allowed values of CWₚ comprises 15, 31 and 63. CW_{min,p} is 15, the next higher allowed value for CW_{min,p} is 31, and the next higher allowed value for CWₚ=31 is 63. At block 310, the first terminal device 110 may set CWₚ=15. If the first terminal device 110 determines that the factor does not satisfy a threshold, the first terminal device 110 may increase CWₚ to 31.

In some embodiments, the allowed values of CWₚ for sidelink terminal devices may be independently defined, configured, pre-configured for sidelink communication. In other words, the allowed values of CWₚ for sidelink terminal devices may be different from those as shown in Table 1.

It will be noted that the factor may be evaluated or measured within a reference duration. The reference duration is a timing window which may be configured, pre-configured or defined accordingly.

In some embodiments, according to a priority of a sidelink signal or information, the CW may be defined per priority. Therefore, a terminal device may implement independent procedure of CW determining per priority.

In some embodiments, if CWₚ=CW_{max,p}, the next higher allowed value for adjusting CWₚ is CW_{max,p}. If CWₚ=CW_{max,p} is consecutively used K times, CWₚ is reset to CW_{min,p} for priority p, where K is configured or pre-configured per priority p.

FIG. 4 illustrates a flowchart of an example method 400 for determining a CW in accordance with some embodiments of the present disclosure. In some embodiments, the method 400 can be implemented at a terminal device, such as the first terminal device 110 or the second terminal device 120 as shown in FIG. 1. For the purpose of discussion, the method 400 will be described with reference to FIG. 1 as performed by the first terminal device 110 without loss of generality.

In the example method 400, a value of a CW is determined based on two factors related to sidelink. The two factors may comprise a first factor related to sidelink and a second factor related to sidelink.

As shown in FIG. 4, similar to block 310, at block 410, the first terminal device 110 sets CWₚ to be CW_{min,p}, i.e., CWₚ=CW_{min,p}.

At block 420, according to the determining rule of CWₚ, the first terminal device 110 determines whether a first factor satisfies the first threshold. If the first factor satisfies the first threshold, the method 400 goes to block 410. Otherwise, the method 400 goes to block 430.

At block 430, according to the determining rule of CWₚ, the first terminal device 110 determines whether a second factor satisfies the second threshold. The second factor is different from the first factor. The second threshold may be the same as or different from the first threshold. The first and second thresholds may be configured, pre-configured or defined independently. If the second factor satisfies the second threshold, the method 400 goes to block 450. Otherwise, the method 400 goes to block 440.

At block 440, the first terminal device 110 increases CWₚ. For example, the first terminal device 110 may increase CWₚ to the next higher allowed value for priority p. For example, allowed values of CWₚ may comprise the allowed values as shown in above Table 1.

At block 450, the first terminal device 110 maintains CWₚ as it is for priority p.

It will be understood that the factor satisfies a threshold means one of the following:
the evaluation or measurement of the factor exceeds the related threshold (for example, the evaluation or measurement of the factor may be equal to or higher than the related threshold, or the evaluation or measurement of the factor may be higher than the related threshold); or
the evaluation or measurement of the factor is below the related threshold (for example, the evaluation or measurement of the factor may be equal to or less than the related threshold, or the evaluation or measurement of the factor may be less than the related threshold).

In some embodiments, the factor may comprises at least one of the following:
a sidelink Hybrid Automatic Repeat Request (HARQ) feedback detected by the first terminal device 110,
a priority of a sidelink signal or information,
a sidelink control information (SCI) received by the first terminal device 110,
a Channel Busy Ratio (CBR) of sidelink, or
a Channel Occupancy Ratio (CR) of sidelink.

Therefore, the first terminal device 110 may determine the value of CW based on one or more items as mentioned above.

Hereinafter, some embodiments of determining CW based on the sidelink HARQ feedback will be described.

The sidelink HARQ feedback can be supported in unlicensed band, and a terminal device may send positive acknowledge (ACK, also referred to as A) or negative acknowledges (NACK, also referred to as N) on Physical Sidelink Control Channel (PSCCH) or Physical Sidelink Feedback Channel (PSFCH). According to configuration or pre-configuration, a terminal device may feedback ACK/NACK related to sidelink unicast, groupcast, or broadcast.

The first terminal device 110 may try to detect all HARQ feedbacks on sidelink. In some embodiments, the HARQ feedback may comprise one or more HARQ feedbacks associated with sidelink transmission of the first terminal device 110. This type of HARQ feedbacks may be referred to as a first type of HARQ feedbacks or a first type of ACK/NACK hereinafter.

In some embodiments, the HARQ feedback may include at least one HARQ feedback on at least one potential feedback resource. This type of HARQ feedbacks may be referred to as a second type of HARQ feedbacks or a second type of ACK/NACK hereinafter. For example, the second type of HARQ feedbacks may only comprise one or more HARQ feedbacks associated with sidelink transmission of other sidelink terminal devices than the first terminal device 110. For another example, the second type of HARQ feedbacks may comprise one or more HARQ feedbacks associated with sidelink transmission of both other sidelink terminal devices and the first terminal device 110. For another example, the second type of HARQ feedbacks may only comprise one or more HARQ feedbacks associated with sidelink transmission of the first terminal device 110.

On sidelink, there are different schemes of ACK or NACK feedback. For example, a terminal device receiving sidelink transmission may report ACK or NACK according to the receiving result of PSSCH. Hereinafter, the terminal device receiving sidelink transmission may be referred to as Rx terminal device. Alternatively or additionally, the Rx terminal device may report NACK only when PSSCH is not received correctly, but does not report ACK otherwise. Besides, it may be independently configured whether ACK or NACK of unicast, groupcast or broadcast is needed to be reported.

Using sidelink HARQ feedback as the factor, the first terminal device 110 may determine and adjust CW flexibly and timely because it reflects the channel condition directly.

According to the sidelink feedback schemes, the first terminal device 110 may use different rules to evaluate the factor and further determine CW. Using sidelink HARQ feedback as the factor, the first terminal device 110 may determine the factor depending on at least one of the following:
the number of positive acknowledges (ACKs) detected by the first terminal device 110,
the number of negative acknowledges (NACKs) detected by the first terminal device 110,
power of ACK detected by the first terminal device 110,
power of NACK detected by the first terminal device 110,
energy of ACK detected by the first terminal device 110, or
energy of NACK detected by the first terminal device 110.

In some embodiments, the at least one sidelink HARQ feedback may comprise at least one of the following:
the first type of HARQ feedbacks,
the second type of HARQ feedbacks,
a HARQ feedback on a potential sidelink control information resource,
a HARQ feedback associated with a sidelink unicast transmission,
a HARQ feedback associated with a sidelink groupcast transmission, or
a HARQ feedback associated with a sidelink broadcast transmission.

In some embodiments, the number of ACKs comprises the number of ACKs for at least one transmission block (TB) or at least one Code Block Group (CBG), and the number of NACKs comprises the number of NACKs for the at least one TB or the at least one CBG.

In some embodiments, the first terminal device 110 may determine a first ratio of the number of ACKs to one of the following or a second ratio of the number of NACKs to one of the following:
the number of sub-channels or interlaces within a reference duration,
the number of Physical Sidelink Shared Channel (PSSCH) resources within the reference duration,
the number of Physical Sidelink Control Channel (PSCCH) resources within the reference duration,
the number of sidelink control information detected within the reference duration,
the number of Physical Sidelink Feedback Channel (PSFCH) resources within the reference duration,
the number of terminal devices in a group,
the number of sidelink Channel Occupancy (CO) within the reference duration,
the number of sidelink CO which contains PSSCH transmission within the reference duration,
the number of sidelink CO which contains PSCCH transmission within the reference duration,
the number of sidelink CO which contains PSFCH transmission within the reference duration,
the number of TBs transmitted by a sidelink terminal device within the reference duration,
the number of TBs transmitted by the first terminal device within the reference duration,
the number of TBs detected by the first terminal device within the reference duration, or
the number of CBGs of a TB transmitted or detected by the first terminal device 110.

As mentioned above, using the sidelink HARQ feedback as the factor may contain multiple practical schemes. Without conflict, any combination of the above items may be used for sidelink CW determination.

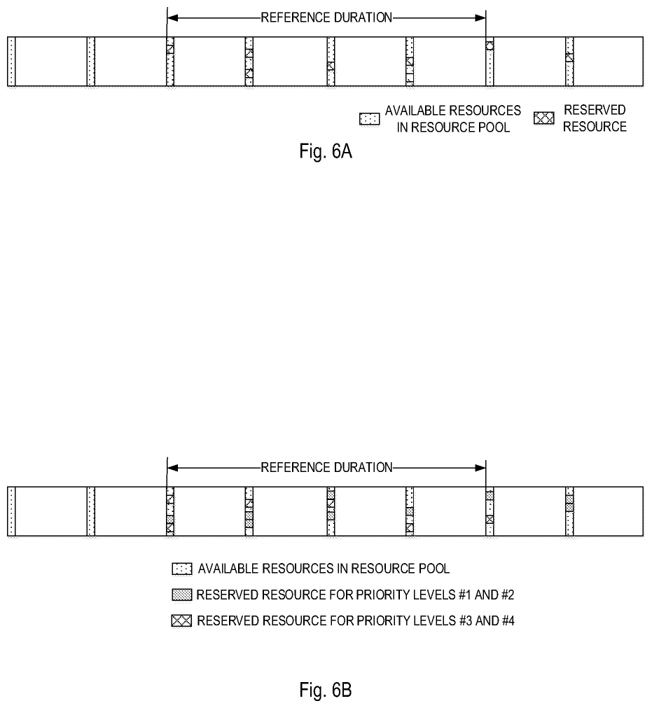

Hereinafter, some examples of determining CW for SL-U based on sidelink HARQ feedback will be described with reference to FIGS. 5A to 5D. For the purpose of discussion, the examples will be described with reference to the general procedure in FIG. 3.

FIGS. 5A, 5B and 5C illustrate an example of sidelink HARQ feedbacks in accordance with some embodiments of the present disclosure, respectively. In the examples of FIGS. 5A and 5B, the first terminal device 110 determines CWₚ according to the number of ACKs or NACKs detected within a reference duration. The first type of HARQ feedbacks are used as factor. For unicast, the first type of HARQ feedbacks are from one or more terminal devices receiving sidelink transmission from the first terminal device 110. For groupcast, the first type of HARQ feedbacks may be reported by one or multiple terminal devices receiving sidelink transmission from the first terminal device 110, i.e., member terminal devices in a group.

For unicast or groupcast communication, a terminal device (for example, the first terminal device 110) transmitting the sidelink transmission may identify one or more Rx terminal devices and it is easier to obtain the ACK or NACK report. The number of ACKs may present the channel status and possibility of successful sidelink transmission, and further benefit CW adjustment procedure. Hereinafter, the terminal device transmitting the sidelink transmission may be also referred to as Tx terminal device.

For sidelink unicast communication in unlicensed band, the Rx terminal device can report ACK or NACK feedback to the Tx terminal device. Then, the Tx terminal device may detect ACK or NACK reported by the Rx terminal device and further determine CW for channel access procedure for sidelink transmission according to the number of the received ACKs. A threshold of the number of ACKs for unicast may be defined to determine CW accordingly.

For sidelink groupcast communication in unlicensed band, the Rx terminal devices can report ACK or NACK feedback to the Tx terminal device. Then, the Tx terminal device can detect ACK or NACK reported by more than one Rx terminal devices and further determine CW for channel access procedure according to the number of ACK received. A threshold for the number of ACKs or NACKs for groupcast may be defined to determine CW accordingly.

In the examples of FIGS. 5A and 5B, the ACK reflects to the sidelink transmission of a Tx terminal device, i.e., the Tx terminal device using the first type of ACKs as the factor. The threshold for the number of ACKs may be pre-configured or defined as M. Tx terminal device performs sidelink unicast with Rx terminal device and indicates Rx terminal device to report ACK or NACK. The first type of ACKs is used as factor. Thus, Tx terminal device determines CW according to the ACK which reflects the receiving result of its own transmission. Within a reference duration of ACK or NACK, Tx terminal device detects and receives feedback from Rx terminal device, and figures up the number of ACKs received.

As shown in FIG. 5A, within a reference duration #1, Tx terminal device receives ACK or NACK report from Rx terminal device and three ACKs are detected by the Tx terminal device. As shown at block 320 in FIG. 3, Tx terminal device determines that the factor (which is equal to 3) exceeds the threshold M=1. Then, the method 300 goes to block 310 at which Tx terminal device determines CWₚ=CW_{min,p}.

Within a reference duration #2, Tx terminal device receives ACK or NACK report from Rx terminal device and no ACK is detected. As shown at block 320 in FIG. 3, Tx terminal device determines that the factor is below the threshold M=1. Then, the method 300 goes to block 330 at which Tx terminal device increases CWₚ to the next higher allowed value.

In the example of FIG. 5B, the threshold for the number of ACKs is pre-configured, i.e., M=3. Tx terminal device performs sidelink groupcast with member terminal devices in a group and indicates member terminal devices to report ACK/NACK. The first type of ACKs are used as the factor. Within a reference duration of ACK/NACK, Tx terminal device detects and receives feedback from Rx terminal devices, and figures up the number of ACKs received.

As shown in FIG. 5B, within a reference duration #1, Tx terminal device receives ACK/NACK report from Rx terminal devices, and the number of ACKs is 7. As shown at block 320 in FIG. 3, Tx terminal device determines that the factor (which is equal to 7) exceeds the threshold M=3. Then, the method 300 goes to block 310 at which Tx terminal device determines CWₚ=CW_{min,p}.

Within a reference duration #2, Tx terminal device receives ACK or NACK report from Rx terminal device and the number of detected ACKs is 2. As shown at block 320 in FIG. 3, Tx terminal device determines that the factor (which is equal to 2) is below the threshold M=3. Then, the method 300 goes to block 330 at which Tx terminal device increases CWₚ to the next higher allowed value.

In the example of FIG. 5C, the first terminal device 110 determines CWₚ according to the first ratio or second ratio. The second type of ACKs is used as the factor. The first ratio may be evaluated based on the quantity of PSSCH/PSFCH resources, or the number of SCI detected.

Considering that multiple terminal devices may transmit on sidelink in unlicensed band, using the detection of all the potential ACK/NACK can present the evaluation for transmission result of more terminal devices. Furthermore, the terminal device determines CW according to the first ratio evaluated by all the candidate resources may be more efficient.

For sidelink communication, the potential resources to be used, e.g., candidate start position in time domain for sidelink transmission, the resources can be used for sidelink channels, or the channel structure, may be pre-configured for terminal devices. Based on that, the possible maximum number of resources or sidelink channels can be determined. Further, the first ratio can be evaluated accordingly.

In this example, the first terminal device 110 tries to detect all the ACK/NACK signal in the unlicensed band, which reflects to the sidelink transmission of different Tx terminal device(s), i.e., the terminal device using the second type of ACKs as the factor.

In this example, a threshold for the first ratio is defined as a fixed value, i.e., Z=5%. The first terminal device 110 should blind detect and figure up the number of ACKs within a reference duration, and divide it by the number of relevant resources or channels. In this example, the second type of ACKs is used as the factor, i.e., the first terminal device 110 may try to detect all the potential ACK on sidelink, and then evaluate the first ratio and further determine CW accordingly.

Specifically, the maximum number of PSFCH resources within a reference duration may be determined according to the sidelink channel structure and configuration in unlicensed band. Based on that, the first ratio can be evaluated as: the number of ACKs detected by the first terminal device 110 divided by the number of PSFCH resources within a reference duration.

As shown in FIG. 5C, within a reference duration, the first terminal device 110 detects ACK/NACK on PSFCH resources and figures up the number of detected ACKs. Then, the first terminal device 110 evaluates the factor, i.e., the first ratio, by dividing the number of ACKs to the number of PSFCH resources. If the first ratio is equals to or higher than the threshold Z=5%, as shown at block 320 in FIG. 3, the first terminal device 110 determines CWₚ=CW_{min,p}; otherwise, the first terminal device 110 increases CWₚ to the next higher allowed value.

For another example (not shown), the first ratio may be determined depending on the number of PSSCH resources, which reflects the potential number of sidelink data transmission. The number of PSSCH resources within a reference duration may be determined according to the sidelink channel structure and configuration in unlicensed band. Based on that, the first ratio may be evaluated as: the number of ACKs detected by the first terminal device 110 divided by the number of PSSCH resources within the reference duration.

Within the reference duration, the first terminal device 110 detects A/N and figures up the number of detected ACKs. Then, the first terminal device 110 evaluates the factor, i.e., the first ratio, by dividing the number of ACKs to the number of PSSCH resources. If the first ratio is equals to or higher than the threshold Z=5%, as shown at block 320 in FIG. 3, the first terminal device 110 determines CWₚ=CW_{min,p}; otherwise, the first terminal device 110 increases CWₚ to the next higher allowed value.

Similar to the above example, the first ratio may be evaluated as:
the number of ACKs divided by the number of sub-channels within the reference duration;
the number of ACKs divided by the number of interlaces within the reference duration; or
the number of ACKs divided by the number of SCI detected within the reference duration.

In some embodiments, the first terminal device 110 may determine the value of CW based on NACK detected within a reference duration (NACK only case). In such embodiments, the first terminal device 110 may use the second ratio or power of NACK as the factor. The power of NACK may be defined as Reference Signal Receiving Power (RSRP) of the relevant resource.

For the scenario in which ACK is unavailable, using NACK related information as the factor can provide reasonable reference for CW determining. Specifically, the evaluation scheme based on the power or energy of NACK is more feasible by the terminal device.

Specifically, for sidelink groupcast communication, NACK only feedback scheme may be configured, by which Rx terminal device only reports NACK on sidelink when it fails to decode data on PSSCH resource, and no ACK would be reported. For this scenario, NACK detected by a terminal device should be used as the factor, and CW may be determined according to the evaluation of NACK comparing to the relative threshold.

For the case that Rx terminal devices in a group use independent feedback resources to send NACK, Tx terminal device may identify each NACK and evaluate the second ratio by dividing the number of received NACKs by the number of terminal devices in the group. A threshold for the second ratio may be pre-configured.

For the case that more than one terminal devices report NACK on the same resource, i.e., multiple NACK signals may be overlapped, Tx terminal device may measure the signal power on the feedback resource. Therefore, a RSRP or RSRQ of a signal on a PSFCH resource can be used as the threshold.

In an example, the threshold for the second ratio is defined as a fixed value represented by Z. For example, Z=60%. Tx terminal device performs sidelink groupcast transmission with member terminal devices in a group and indicates member terminal devices to feedback using NACK only scheme. That is, when there is failure of receiving data on PSSCH, member terminal devices send NACK to Tx terminal device. According to the configuration of feedback scheme, each member terminal device in the group has a dedicated feedback resource, and Tx terminal device can identify NACK from different member terminal devices. Within a reference duration, Tx terminal device detects and receives feedback from member terminal devices, and figures up the total number of detected NACKs.

Within the reference duration, Tx terminal device detects NACK on feedback resources and figures up the number of detected NACK. Then, Tx terminal device evaluates the factor, i.e., the second ratio by dividing the number of NACK to the number of member terminal devices. If the second ratio is below the threshold Z=60%, as shown at block 320 in FIG. 3, Tx terminal device determines CWₚ=CW_{min,p}; otherwise, Tx terminal device increases CWₚ to the next higher allowed value.

In another example, the threshold of a power related to the signal detected in a PSFCH resource is defined in system, which is represented by P. Tx terminal device performs sidelink groupcast transmission with member terminal devices in a group and indicates member terminal devices to report NACK on the same resource if there is failure of receiving data. According to the configuration of feedback scheme, the member terminal devices which fail to decode the transmission would send NACK signal on the indicated resource. Then, Tx terminal device may measure the RSRP of the feedback resource, and determine CW by comparing the received RSRP of NACK to the threshold.

Within a reference duration, Tx terminal device measures the signal power of the feedback resource. If the RSRP of the feedback resource used for NACK is below the threshold P, as shown at block 320 in FIG. 3, Tx terminal device determines CWₚ=CW_{min,p}; otherwise, Tx terminal device increases CWₚ to the next higher allowed value.

In some embodiments, the first terminal device 110 may determine the value of CW according to both ACK and NACK detected within a reference duration.

For the case that different HARQ feedback schemes are used simultaneously, a terminal device may determine CW according to devious conditions of A/N detection. This case relates to a scheme which can be used for a hybrid scenario of sidelink feedback schemes.

Specifically, for sidelink communication, both A/N feedback scheme and NACK only feedback scheme may be configured in the same resource pool. It is to say, Tx terminal device may receive ACK or NACK on sidelink feedback resources, and the CW determining procedure may be defined based on the situation of both ACK and NACK.

In an embodiment, the CW may be determined according to both ACK and NACK. Specifically, the first ratio and the receiving energy of NACK may be used as factors. Thresholds are configured by Road Side Unit (RSU). For example, a threshold for the first ratio may be represented by Z and a threshold for energy of NACK may be represented by Tᵣₑₛ, Z=5%. Accordingly, the terminal device may determine CW based on the thresholds and situation of A/N receiving, which will described with reference to FIG. 5D.

FIG. 5D illustrates a flowchart of an example method 500 for determining a CW in accordance with some embodiments of the present disclosure. In some embodiments, the method 500 can be implemented at a terminal device, such as the first terminal device 110 or the second terminal device 120 as shown in FIG. 1. For the purpose of discussion, the method 500 will be described with reference to FIG. 1 as performed by the first terminal device 110 without loss of generality.

In the example method 500, both ACK and NACK related information are used as factors.

As shown, at block 510, the first terminal device 110 sets CWₚ=CW_{min,p}, where CW_{min,p} represents the minimum value of CWₚ for priority p.

At block 520, the first terminal device 110 determines whether ACK on sidelink is detected. In other words, the first terminal device 110 determines whether ACK on sidelink is available. If ACK on sidelink is available, the method 500 goes to block 530; otherwise, the method 500 goes to block 550.

At block 530, the first terminal device 110 determines whether the first ratio is not below Z. If the first ratio is not below Z, the method 500 goes to block 510 at which the first terminal device 110 determines CWₚ=CW_{min,p}. Otherwise, the method 500 goes to block 540.

At block 540, the first terminal device 110 increases CWₚ to the next higher allowed value for priority p.

At block 550, the first terminal device 110 determines whether the signal energy of the resource used for NACK is below Tᵣₑₛ. If the signal energy of the resource used for NACK is below Tᵣₑₛ, the method 500 goes to block 560. Otherwise, the method 500 goes to block 540.

At block 560, the first terminal device 110 maintains CWₚ as it is for priority p.

In some embodiments, a sidelink terminal device may obtain information by detecting and decoding SCI and further determine CW based on the information obtained from SCI. Hereinafter, some embodiments of determining CW based on the SCI received by the first terminal device 110 will be described.

In some embodiments, the information received from SCI may be used as one or more factors independently, or combined with other factors to determine CW.

The indication in SCI of other sidelink terminal devices may provide extra assistant information in CW determining. By using the indication from SCI, the CW determining may be more efficient and benefit the resource selection of sidelink.

In some embodiments, the first terminal device 110 may blindly detect and decode SCI on sidelink resources in which at least one of the following indications may be identified:
ACK or NACK indication,
Priority of the data packet on relevant PSSCH,
Cast type of the relevant PSSCH,
One or more resources used for the relevant PSSCH,
One or more resources reserved for the data packet, or
Number of retransmissions.

The one or more resources used for relevant PSSCH or reserved for relevant data packet may include the indication of location or number of sub-channels or interlaces used for PSSCH, and slot(s) index or interval between current slot and the reserved resource(s).

In some embodiments, any one or more of the indications as listed above in SCI may be used as factor(s) in CW determining.

For sidelink terminal devices, the resource reservation indication may be obtained from SCI which indicates the resources would be used in the following slots. It means that the reserved resource should not be used by other sidelink terminal devices.

Accordingly, a third ratio which is related to reserved resource may reflect the channel status in some extent, determining CW based on the third ratio may optimize the resource selection for sidelink terminal devices.

Hereinafter, some embodiments of determining CW based on one or more reserved resources indicated by SCI will be described.

SCI is transmitted by one or more sidelink terminal devices in which at least one resource reserved for at least one retransmission or the next transmission of the Tx terminal device is indicated. By decoding one or more pieces of SCI of other terminal devices, a sidelink terminal device can obtain the information and avoid to use the resources reserved by other terminal devices.

In SCI, the reserved resource may be indicated through at least one of the followings:
the number of sub-channels or interlaces of reserved resources;
the location of sub-channels or interlaces of reserved resources;
the slot of reserved resources;
the slot interval of reserved resources, including slot interval between the slot of the SCI and reserved resources, or slot interval between adjacent reserved resources; or
the period of transmission.

Based on the indication of at least one reserved resource, the first terminal device 110 may evaluate the number of reserved resources according to at least one of the followings:
the number of sub-channels or interlaces indicated by the SCI within the reference duration,
the number of retransmissions indicated by the SCI within the reference duration, or
the number of periodic transmissions according to a period indicated by the SCI within the reference duration.

Furthermore, the third ratio related to reserved resources may be determined as the number of reserved resources divided by the number of available resources within the reference duration.

In some embodiments, the number of available resources within a reference duration may be determined according to at least one of the followings:
the number of slots within the reference duration,
the number of sub-channels or interlaces in a slot, or
the number of slots in a sidelink resource pool within the reference duration.

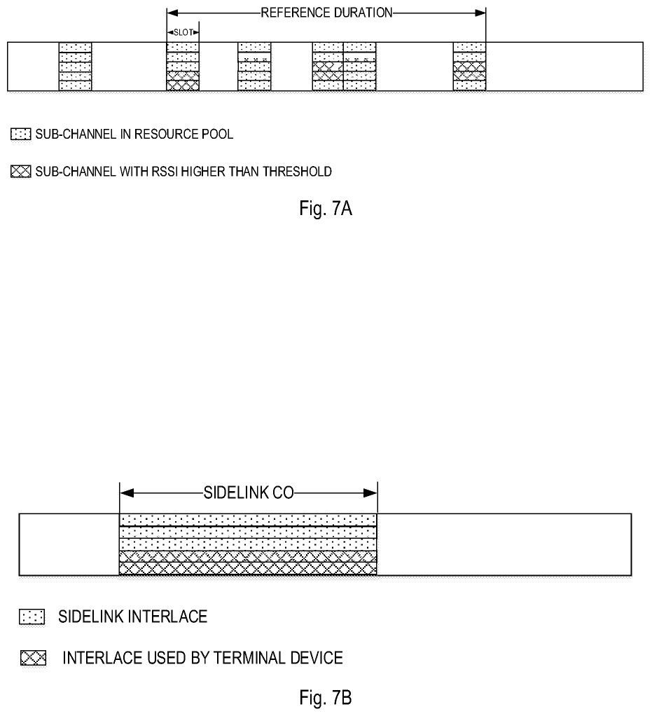

Hereinafter, an example of determining CW based on reserved resources will be described with reference to FIG. 6A. For the purpose of discussion, the example will be described with reference to the general procedure in FIG. 3.

In the examples of FIG. 6A, a threshold for the third ratio is pre-configured and represented by R. For example, R=60%. The first terminal device 110 may blind detect SCI on PSCCH and evaluate the number of reserved resources within a reference duration. Then, the first terminal device 110 may determine the third ratio by dividing the number of reserved resources by the number of available resources within the reference duration.

In this example, the number of reserved resources is the number of sub-channels of slots within the reference duration, and the number of available resources is determined as the number of sub-channels and slots in a resource pool within the reference duration.

Specifically, the number of sub-channels and the number of slots in a resource pool may be determined according to the sidelink channel structure and configuration in unlicensed band. As shown in FIG. 6A, the number of reserved resources is 6 and the number of available resources is 24. Thus, the ratio of the number of reserved resources to the number of available resources is 25% which is below the threshold (60%). Therefore, as shown at block 320 in FIG. 3, the first terminal device 110 determines CWₚ=CW_{min,p}.

In some embodiments, the data packet transmitted on sidelink may have different priorities, and Tx terminal device may determine CW depending on the third ratio of relevant priority, and the priority of its own transmission. A threshold for the third ratio may be assigned per priority. In other words, the threshold for the third ratio may be configured for each of the priority of data.

By considering the priority of sidelink data packet, a terminal device with higher priority requirement may have more opportunity to occupy the channel resource. Therefore, it benefits the performance of sidelink system.

In some embodiments, the first terminal device 110 may obtain the threshold for the third ratio from a network device. For example, for priority level #1, the threshold for the third ratio is R1; for priority level #2, the threshold for the third ratio is R2, and so on. The first terminal device 110 may blind detect SCI on PSCCH and evaluate the number of reserved resources per priority within a reference duration, and then divide it by the number of available resources within the reference duration.

Specifically, for the first terminal device 110 to determine CW for its own transmission, the data packet to be transmitted is with priority level #3. Then the first terminal device 110 may detect SCI within the reference duration and determine the third ratio with the priority higher than its own transmission.

Hereinafter, an example of determining CW based on reserved resources and priority of the reserved resources will be described with reference to FIG. 6B. For the purpose of discussion, the example will be described with reference to the general procedure in FIG. 3.

As shown in FIG. 6B, the first terminal device 110 determines the third ratio with the priority levels #1 and 2, and the resources reserved for priority levels #3 and 4 are not included in determining the third ratio. Based on that, the first terminal device 110 may further determine the CW by comparing the third ratio to the threshold of the ratio relative to priority level #3.

Within a reference duration, the first terminal device 110 detects one or more pieces SCI on PSCCH resources and figures up the number of reserved resources for priority level #1 and level #2 as its data packet to be transmitted is with priority level #3. Then, the first terminal device 110 evaluates the factor, i.e., the third ratio of higher priority level than its own transmission, by dividing the number of reserved resources with priority levels #1 and #2 to the number of available resources. If the third ratio is below the threshold R3, as shown at block 320 in FIG. 3, the first terminal device 110 determines CWₚ=CW_{min,p}; otherwise, the first terminal device 110 increases CWₚ to the next higher allowed value.

In some embodiments, the first terminal device 110 may determine CW according to one or more retransmission numbers indicated in at least one piece of SCI.

The number of retransmissions reflects the channel status in some extent, i.e., the more retransmission, the lower transmission success rate and the worse channel status. Therefore, using the number of retransmissions as the factor may provide more efficient determining of CW.

Within a reference duration, by decoding one or more pieces of SCI on sidelink control channel, the first terminal device 110 may obtain retransmission numbers of other Tx terminal devices. Accordingly, the following information may be evaluated by the first terminal device 110:
the maximum value of the retransmission numbers within the reference duration;
the average value of the retransmission numbers within the reference duration.

It will be understood that in some embodiments, the first terminal device 110 may obtain one retransmission number of other Tx terminal device within the reference duration. In such embodiments, each of the maximum value of the retransmission numbers and the average value of the retransmission numbers is equal to the retransmission number.

A threshold for the retransmission numbers may be configured by RSU to the sidelink terminal devices served by the RSU. In detail, the threshold assigned may be a threshold of the maximum value of the retransmission numbers, or a threshold of the average value of the retransmission numbers.

In an example, the first terminal device 110 detects one or more pieces of SCI on PSCCH resources and records the maximum value of the retransmission numbers within a reference duration. Then, the first terminal device 110 compares the factor, i.e., the maximum value of the retransmission numbers, to the relevant threshold. If the maximum value of the retransmission numbers is equals to or less than the threshold, as shown at block 320 in FIG. 3, the first terminal device 110 determines CWₚ=CW_{min,p}; otherwise, the first terminal device 110 increases CWₚ to the next higher allowed value.

In some embodiments, for sidelink communication in unlicensed band, the sidelink related measurements, such as CBR of sidelink in unlicensed band, may also be evaluated by the first terminal device 110 and used for CW determining. Hereinafter, CBR of sidelink may be also referred to as SL CBR

SL CBR is a dedicated parameter which presents the channel status of sidelink and used for sidelink resource selection. In unlicensed band, using the similar measurements in unlicensed band may provide additional benefits for CW determining, especially for the scenarios of other factors unavailable.

In some embodiments, SL CBR may be determined as one of the followings:
a portion of sub-channels or interlaces in a sidelink resource pool whose power or energy measured by the first terminal device 110 exceed a threshold within a reference duration, or
a portion of sub-channels or interlaces whose power or energy measured by the first terminal device 110 exceed the threshold within the reference duration.

In some embodiments, power or energy measured by the first terminal device 110 may be represented by one of the following: Received Signal Strength Indicator (RSSI), Reference Signal Receiving Power (RSRP), or Reference Signal Receiving Quality (RSRQ).

For a sidelink terminal device working in unlicensed band, a threshold for SL CBR may be pre-configured per priority, i.e. a dedicated threshold for SL CBR for each priority of data. According to the threshold, the first terminal device 110 may determine the CW according to the threshold relevant to the priority of its own transmission and SL CBR measured within a reference duration. As the CW is determined based on priority and SL CBR, it may provide different possibility for terminal devices and benefit the performance of sidelink system.

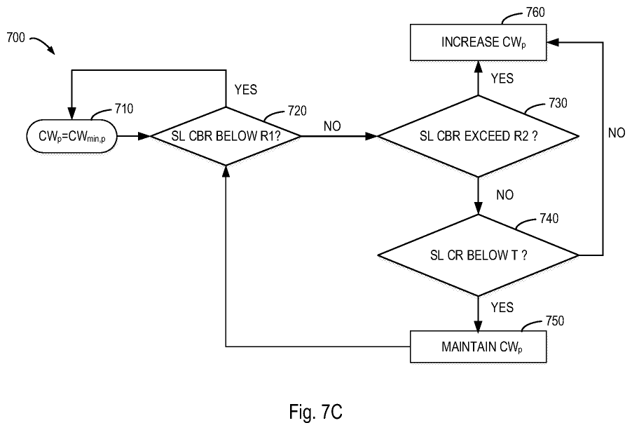

Hereinafter, an example of determining CW based on SL CBR will be described with reference to FIG. 7A.

In the example, the first terminal device 110 obtains the threshold for the SL CBR of each priority according to system pre-configuration. For example, for priority level #1, the threshold is R1; for priority level #2, the ratio threshold is R2, and so on. The first terminal device 110 may measure the signal strength per sub-channel and figure out the number of sub-channels which are with RSSI higher than a threshold for RSSI, and then divided it by a total number of configured sub-channels in the transmission pool in the reference duration. It should be understood that the threshold for RSSI is different from thresholds R1 and R2 for SL CBR.

In detail, for the first terminal device 110 to determine CW for its own transmission, the data packet to be transmitted is with priority level #3. The first terminal device 110 may measure the RSSI of sidelink resources within a reference duration and evaluate the SL CBR using the RSSI threshold which is pre-configured by system. Based on that, the first terminal device 110 may further determine the CW by comparing the measurement of SL CBR to the threshold relative to priority level #3.

Within a reference duration, the first terminal device 110 detects signals on PSSCH resources and measures RSSI of sidelink sub-channel, then figure outs the number of sub-channels with RSSI higher than the related threshold. As shown in FIG. 7A, the number of sub-channels with RSSI higher than the related threshold is 8.

Then, the first terminal device 110 evaluates the factor, i.e., SL CBR, by dividing the number of sub-channels with RSSI higher than the threshold to the number of sub-channels within the reference duration. The number of sub-channels within the reference duration may be determined according to the number of sub-channels in the resource pool and the number of slots in the reference duration, where the number of sub-channels in the resource pool may be determined according to the sidelink channel structure and configuration in unlicensed band. Based on that, the SL CBR may be determined. As shown in FIG. 7A, the number of sub-channels within the reference duration is 25. Thus, the SL CBR is equals to 8/25=32%.

If the SL CBR is equals to or less than the threshold R3, as shown at block 320 in FIG. 3, the first terminal device 110 determines CWₚ=CW_{min,p}; otherwise, the first terminal device 110 increases CWₚ to the next higher allowed value.

In some embodiments, for sidelink communication in unlicensed band, CR of sidelink is also a dedicated parameter which presents the channel status of sidelink and used for sidelink resource selection. CR of sidelink in unlicensed band may also be evaluated by the first terminal device 110 and used for CW determining. Hereinafter, CR of sidelink may be also referred to as SL CR.

In some embodiments, SL CR may be determined as one of the followings:
a total number of sub-channels used for transmission of the first terminal device 110 divided by a total number of sub-channels in a sidelink resource pool within a reference duration,
a total number of sub-channels used for transmission of the first terminal device 110 divided by a total number of sub-channels within the reference duration,
a total number of interlaces used for transmission of the first terminal device 110 divided by a total number of interlaces in the sidelink resource pool within the reference duration, or
a total number of interlaces used for transmission of the first terminal device 110 divided by a total number of interlaces within the reference duration.

For sidelink terminal device worked in unlicensed band, the threshold for SL CR may be pre-configured per priority, i.e. a dedicated threshold for SL CR for each priority of data. According to the threshold, terminal device may determine the CW according to the threshold relevant to the priority of its own transmission and SL CR measured within a reference duration. As the CW is determined based on priority and SL CR, it may provide different possibility for terminal devices and benefit the performance of sidelink system.

Hereinafter, an example of determining CW based on SL CR will be described with reference to FIG. 7B.

In the example, the first terminal device 110 obtains the threshold for the SL CR of each priority according to system pre-configuration. For example, for priority level #1, the threshold is R1, for priority level #2; the ratio threshold is R2, and so on. The first terminal device 110 may evaluate the number of interlaces which has been used and/or to be used for its sidelink transmission within a reference duration, and then divide it by a total number of configured interlaces within the reference duration.

In detail, for the first terminal device 110 to determine CW for its own transmission, the data packet to be transmitted is with priority level #3. Based on that, the first terminal device 110 may determine the CW by comparing its SL CR to the threshold relative to priority level #3.

In the example of FIG. 7B, the reference duration is represented by sidelink channel occupancy (CO) time. With the reference duration, the first terminal device 110 figures out the number of interlaces used in last sidelink CO. As shown in FIG. 7B, the number of interlaces used in last sidelink CO is 2.

Then the first terminal device 110 evaluates the factor, i.e., SL CR, by dividing the number of interlaces used for it sidelink transmission to the number of interlaces in the CO. Specifically, the number of interlaces within a reference duration may be determined according to the number of interlaces for sidelink communication which may be determined according to the sidelink resource configuration in unlicensed band. As shown in FIG. 7B, the number of interlaces in the CO is 5.

If the SL CR is equals to or less than the threshold R3, as shown at block 320 in FIG. 3, the first terminal device 110 determines CWₚ=CW_{min,p}; otherwise, the first terminal device 110 increases CWₚ to the next higher allowed value.

In some embodiments, the first terminal device 110 may determine the CW based on SL CBR and SL CR. The SL CBR presents the channel status of other terminal devices transmission while the SL CR illustrates the resource used by the terminal device itself to determine CW for its own transmission. By combining the two factors, a more suitable CW may be determined and further decrease the possibility of resource conflicts.

Hereinafter, an example method 700 of determining CW based on SL CBR and SL CR will be described with reference to FIG. 7C.

In the example 700, both SL CR and CBR are used for determining CWₚ by the first terminal device 110. The definitions of SL CR and SL CBR are the same as the above embodiments, and SL CR and SL CBR are evaluated based on sub-channel.

SL CBR is used as a first factor related to sidelink and SL CR is used as a second factor related to sidelink for CWₚ determining. A first threshold R1 and a second R2 for SL CBR as well as a third threshold T for CR are configured by a network device.

As shown in FIG. 7C, at block 710, the first terminal device 110 sets CWₚ=CW_{min,p}, where CW_{min,p} represents the minimum allowed value of CWₚ for priority p.

At block 720, the first terminal device 110 determines whether SL CBR is below the first threshold R1. If SL CBR is below the first threshold R1, the method 700 goes to block 710 at which the first terminal device 110 sets CWₚ=CW_{min,p}. If SL CBR is not below the first threshold R1, the method 700 goes to block 730 at which the first terminal device 110 determines whether SL CBR exceeds the second threshold R2.

If SL CBR does not exceed the second threshold R2, the method 700 goes to block 740 at which the first terminal device 110 determines whether SL CR is below the third threshold T. If SL CBR exceeds the second threshold R2, the method 700 goes to block 760 at which the first terminal device 110 increases CWₚ to the next higher allowed value for priority p.

If SL CR is below the third threshold T, the first terminal device 110 maintains the value of the CWₚ as shown in block 750. If SL CR is not below the third threshold T, the method 700 goes to block 760 at which the first terminal device 110 increases CWₚ to the next higher allowed value for priority p.

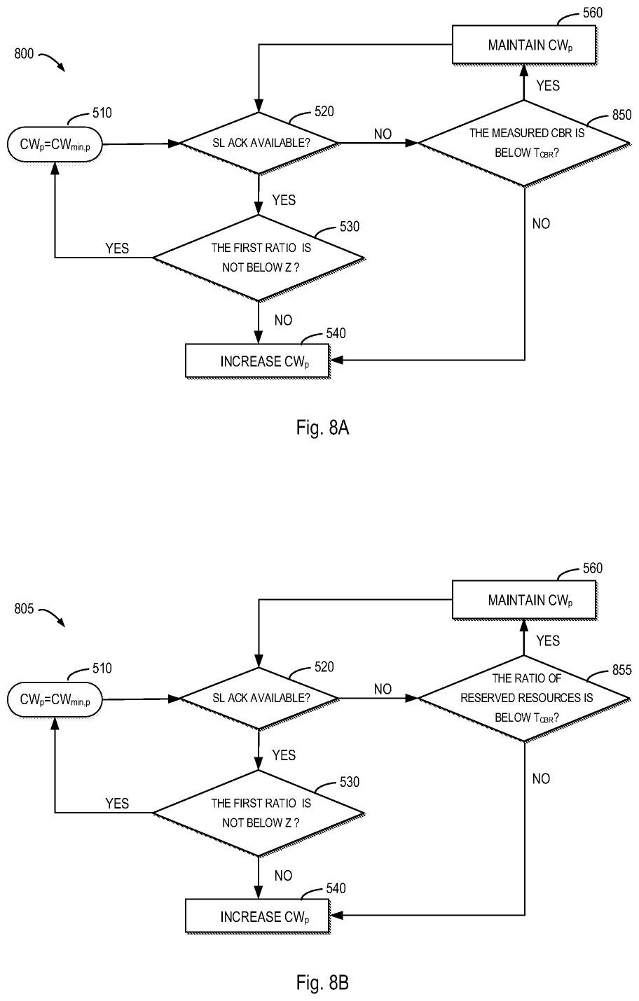

In some embodiments, the first terminal device 110 may determine the CW based on a HARQ feedback and SL CBR, which will be described with reference to FIG. 8A.

FIG. 8A illustrates a flowchart of an example method 800 for determining a CW in accordance with some embodiments of the present disclosure. In some embodiments, the method 800 can be implemented at a terminal device, such as the first terminal device 110 or the second terminal device 120 as shown in FIG. 1. For the purpose of discussion, the method 800 will be described with reference to FIG. 1 as performed by the first terminal device 110 without loss of generality.

The example method 800 is similar to the example method 500. The example method 800 is different from the example method 500 in that at block 850, the first terminal device 110 determines whether the SL CBR is below a threshold T_{CRB}. If the SL CBR is below the threshold T_{CRB}., the method 800 goes to block 560. Otherwise, the method 800 goes to block 540.

In some embodiments, the first terminal device 110 may determine the CW based on a HARQ feedback and a reserved resource indicated in SCI, which will be described with reference to FIG. 8B.

FIG. 8B illustrates a flowchart of an example method 805 for determining a CW in accordance with some embodiments of the present disclosure. In some embodiments, the method 805 can be implemented at a terminal device, such as the first terminal device 110 or the second terminal device 120 as shown in FIG. 1. For the purpose of discussion, the method 805 will be described with reference to FIG. 1 as performed by the first terminal device 110 without loss of generality.

The example method 805 is similar to the example method 500. The example method 805 is different from the example method 500 in that at block 855, the first terminal device 110 determines whether the third ratio within a reference duration is below a threshold Tᵣₑₛ. If the third ratio is below the threshold Tᵣₑₛ, the method 805 goes to block 560. Otherwise, the method 805 goes to block 540.

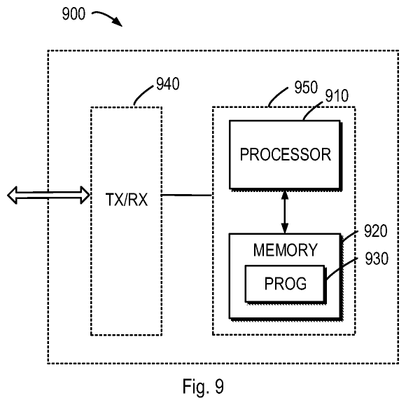

FIG. 9 is a simplified block diagram of a device 900 that is suitable for implementing some embodiments of the present disclosure. The device 900 can be considered as a further example embodiment of the first terminal device 110 or the second terminal device 120 as shown in FIG. 1. Accordingly, the device 900 can be implemented at or as at least a part of the first terminal device 110 or the second terminal device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 920 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 930 is assumed to include program instructions that, when executed by the associated processor 910, enable the device 900 to operate in accordance with the embodiments of the present disclosure, as discussed herein with reference to FIGS. 2 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 8. Generally, program modules include routines, programs, libraries, objects, classes, components, data structures, or the like that perform particular tasks or implement particular abstract data types. The functionality of the program modules may be combined split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-22. (canceled)

23. A method of a User Equipment (UE), the method comprising:
transmitting a Sidelink (SL) transmission including a Physical Sidelink Shared Channel (PSSCH); and
supporting a contention window adjustment procedure for the SL transmission, wherein the contention window adjustment procedure is configured to adjust a value of a Contention Window for a priority class (CWp), and wherein the value of CWp is used for a channel access procedure for the SL transmission.

24. The method according to claim 23,
wherein the contention window adjustment procedure is based on a sidelink Hybrid Automatic Repeat Request (HARQ) feedback in a case where the SL transmission is enabled with the sidelink HARQ feedback.

25. The method according to claim 24,
wherein the contention window adjustment procedure is configured to determine whether a first condition is fulfilled in a case where the SL transmission is enabled with the sidelink HARQ feedback and the SL transmission is a groupcast SL transmission.

26. The method according to claim 25,
wherein the first condition is related to:
a ratio between a number of ACK in the sidelink HARQ feedback and a number of one or more UEs in a groupcast, or
the number of ACK in the sidelink HARQ feedback.

27. The method according to claim 24,
wherein the contention window adjustment procedure is configured to determine whether a second condition is fulfilled in a case where the SL transmission is enabled with the sidelink HARQ feedback and the SL transmission is a unicast SL transmission.

28. The method according to claim 27,
wherein the second condition is related to a number of ACK in the sidelink HARQ feedback and a number of NACK in the sidelink HARQ feedback.

29. The method according to claim 23,
wherein the contention window adjustment procedure is configured to adjust the value of CWp based on the priority class in a case where the SL transmission is not associated with a sidelink Hybrid Automatic Repeat Request (HARQ) feedback.

30. The method according to claim 23,
wherein the UE is configured to perform the channel access procedure.

31. A User Equipment (UE) comprising:
a memory; and
a processor coupled with the memory, wherein the processor is configured to:
transmit a Sidelink (SL) transmission including a Physical Sidelink Shared Channel (PSSCH), and
support a contention window adjustment procedure for the SL transmission, wherein the contention window adjustment procedure is configured to adjust a value of a Contention Window for a priority class (CWp), and wherein the value of CWp is used for a channel access procedure for the SL transmission.

32. The UE according to claim 31,
wherein the contention window adjustment procedure is based on a sidelink Hybrid Automatic Repeat Request (HARQ) feedback in a case where the SL transmission is enabled with the sidelink HARQ feedback.

33. The UE according to claim 32,
wherein the contention window adjustment procedure is configured to determine whether a first condition is fulfilled in a case where the SL transmission is enabled with the sidelink HARQ feedback and the SL transmission is a groupcast SL transmission.

34. The UE according to claim 33,
wherein the first condition is related to:
a ratio between a number of ACK in the sidelink HARQ feedback and a number of one or more UEs in a groupcast, or
the number of ACK in the sidelink HARQ feedback.

35. The UE according to claim 34,
wherein the contention window adjustment procedure is configured to determine whether a second condition is fulfilled in a case where the SL transmission is enabled with the sidelink HARQ feedback and the SL transmission is a unicast SL transmission.

36. The UE according to claim 35,
wherein the second condition is related to a number of ACK in the sidelink HARQ feedback and a number of NACK in the sidelink HARQ feedback.

37. The UE according to claim 31,
wherein the contention window adjustment procedure is configured to adjust the value of CWp based on the priority class in a case where the SL transmission is not associated with a sidelink Hybrid Automatic Repeat Request (HARQ) feedback.

38. The UE according to claim 31,
wherein the UE is configured to perform the channel access procedure.
